(19) United States
(12) Patent Application Publication
(10) Pub. No.: US 2017/0140471 A1
(43) Pub. Date: May 18, 2017

(54) SYSTEM AND METHOD FOR EXTRACTING AND PROVIDING A MEASURE OF TAXABLE INCOME AND AUDIT LIKELIHOOD

(71) Applicants: Massachusetts Institute of Technology, Cambridge, MA (US); The Mitre Corporation, McLean, VA (US)

(72) Inventors: Erik Anders Pieter Hemberg, Belmont, MA (US); Una-May O'Reilly, Weston, MA (US); Jacob Benjamin Rosen, Cambridge, MA (US); Osama Badar, San Francisco, CA (US); Hettithanthrige S. Wijesinghe, Silver Spring, MD (US); Geoffrey Lee Warner, Vienna, VA (US); Uma B. Marques, Leesburg, VA (US)

(73) Assignees: Massachusetts Institute of Technology, Cambridge, MA (US); The Mitre Corporation, McLean, VA (US)

(21) Appl. No.: 15/352,875

(22) Filed: Nov. 16, 2016

Related U.S. Application Data
(60) Provisional application No. 62/255,801, filed on Nov. 16, 2015.
(60) Provisional application No. 62/255,785, filed on Nov. 16, 2015.

(51) Int. Cl. G06Q 40/00

(52) U.S. Cl. CPC G06Q 40/123

(57) ABSTRACT

A system and method for providing a likelihood of auditing a tax return is disclosed. A population of potential solutions of transaction sequences and/or audit score sheets is initialized. Each potential solution in the population is evaluated and assigned an objective score. A subset of the population is selected, preferably a subset with an objective score meeting a predefined criteria. The elected subset is varied using Darwinian concepts, and the previous population is replaced with the new, varied population.

### CROSS-REFERENCE TO RELATED APPLICATIONS

This application claims the benefit of U.S. Provisional Patent Application Ser. No. 62/255,801, filed Nov. 16, 2015, entitled “SYSTEM AND METHOD FOR EXTRACTING AND PROVIDING A MEASURE OF TAXABLE INCOME AND AUDIT LIKELIHOOD”, and U.S. Provisional Patent Application Ser. No. 62/255,785, filed Nov. 16, 2015, entitled “METHOD AND SYSTEM FOR ASSESSING AUDITING LIKELIHOOD” both of which are incorporated by reference herein in their entirety.

### FIELD OF THE INVENTION

The present invention relates to taxable income measuring and extraction, as well as the assessing of audit likelihood.

### BACKGROUND OF THE INVENTION

The taxable income of an individual or a corporation depends strongly on the sale or exchange of any assets owned by the individual or corporation. Such assets have a basis that represents the amount that a taxpayer acquired the asset for. Added to the income of the taxpayer is any difference between the price at which the asset is sold or exchanged and the basis of the asset. In many circumstances, a negative difference between the price of the asset and the basis of the asset may conversely be deducted from the taxable income of the taxpayer. The taxpayer is required to correctly report their taxable income and pay tax accordingly.

To ensure compliance, taxable entities, for example, taxpayers, partnerships, corporations, among others, are legally required to report a number of observables pertaining to their economic activity, such as, for example, but not limited to, information included on a tax return. Tax authorities may then determine whether the reported information is correct, and whether the reported observables indicate activity that is considered abusive in respect to the tax law or accounting rules (referred to herein as detecting non-compliance).

If upon examining the observables contained within the required financial documents, tax authorities suspect non-compliance, they may request additional observables by auditing the taxpayer. Authorities then use those additional observables to determine whether the taxpayer is complying with the tax law. The determination of which observables should initially be required on financial documents is crucial for taxpayer compliance. Accordingly, constructing a model for calculating both tax accounting and likelihood of non-compliance given a set of observables is desirable.

### SUMMARY OF THE INVENTION

The present system and method is an operable model of functionality utilized to result in specific outputs, which is composed of three separate but interrelated aspects:
1. The first aspect addresses the problem with the representation of taxable entities and the subsequent calculation of taxable income resulting from economic activities between them. The present system and method represents taxable entities as nodes with recorded taxable incomes and ownership relations between the entities as edges, which compose network state. Each entity has a collection of assets, which compose their respective portfolio. The assets are properties of the node of the entity. Transactions that represent the sale or exchange of assets between the entities transition the network from one state to another by altering the asset portfolios and taxable income of the relevant entity.
2. The second aspect confronts the problem of how to process an economic transaction and alters the network state mentioned in the first aspect according, to its meaning. Its effect on the network state is described in the first aspect. An economic transaction is first checked for legality and feasibility. In this respect, the law is treated as a series of conditional clauses against which the transaction is compared. If the transaction is legal and feasible, the portfolios of the entities are adjusted to reflect the sale or exchange. Finally, the tax consequences resulting from the transaction result in the updating of the taxable income of the entities involved in the transactions.
3. The third aspect recognizes that there is a problem regarding how observables are recognized within the network state and system presented in the previous two aspects. Within each transaction are a set of observables that are present, and each observable is associated with a numerical value. An audit score is generated as a function of the numerical values and the frequency that the observables occur within the list of transactions.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a schematic diagram illustrating the modules of the present system and method.

FIG. 2 is a schematic diagram of an entity as used by the present system and method.

FIG. 3 is a flowchart of an exemplary embodiment of a method for determining a likelihood of a tax audit.

FIG. 4 is a schematic diagram illustrating an example of a system for executing functionality of the present invention.

### DETAILED DESCRIPTION

Use of the present system and method results in an output of a taxable income value and a determination of whether reported observables indicate activity that is considered abusive in respect to tax law or accounting rules, encapsulated as an audit score. Tax accounting and law is represented as a network model where accounting entities are nodes and the relationships between them are edges. As explained herein, the assets of an entity include a collection of asset properties. Each entity has a taxable income value and an audit score. An audit score is based on a set of observables from the current and previous states of the model. Actions from the entities alter the state of the networks and both the taxable income and audit scores are changed.

The present system and method includes a set of seven modules working together to accomplish a single purpose. The modules may be provided within a computer for purposes of extracting a measure of taxable income and audit likelihood from a sequence of transactions occurring within a network oftaxable entities (e.g., partnerships, taxpayers, corporations, etc.) according to a certain auditing policy.

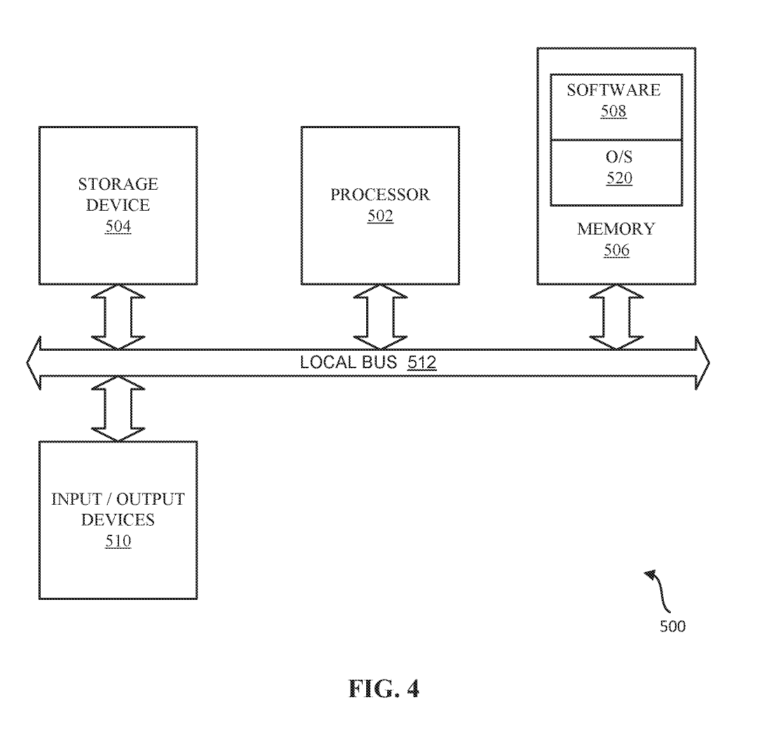

Functionality of the present system and method 100 may be implemented in software, firmware, hardware, or a combination thereof, an example of which is shown in the schematic diagram of FIG. 4. The system 500 contains a processor 502, a storage device 504, a memory 506 having software 508 stored therein that defines the abovementioned functionality, input and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

It should be noted that the computer may contain separate modules, wherein each module contains functionality for execution. As previously mentioned, functionality of the present system and method can be implemented in software, firmware, hardware, or a combination thereof.

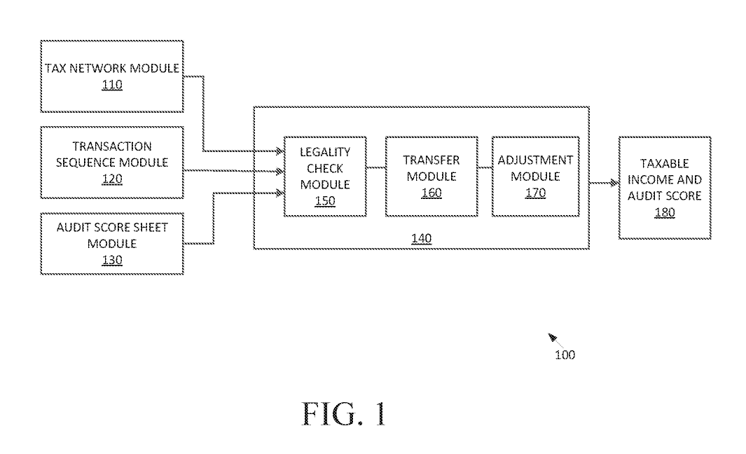

FIG. 1 is a schematic diagram illustrating the modules of the present system and method 100. Referring to FIG. 1, the first three modules (a tax network module 110, a transaction sequence module 120, and an audit score sheet module 130) pertain to representing relevant inputs to the processing modules 140. The processing modules 140 (a legality check module 150, a transfer module 160, and an adjustment module 170) pertain to the processing of financial activity and the production of taxable income. A final module (the audit score module 180) pertains to how the system produces an audit likelihood.

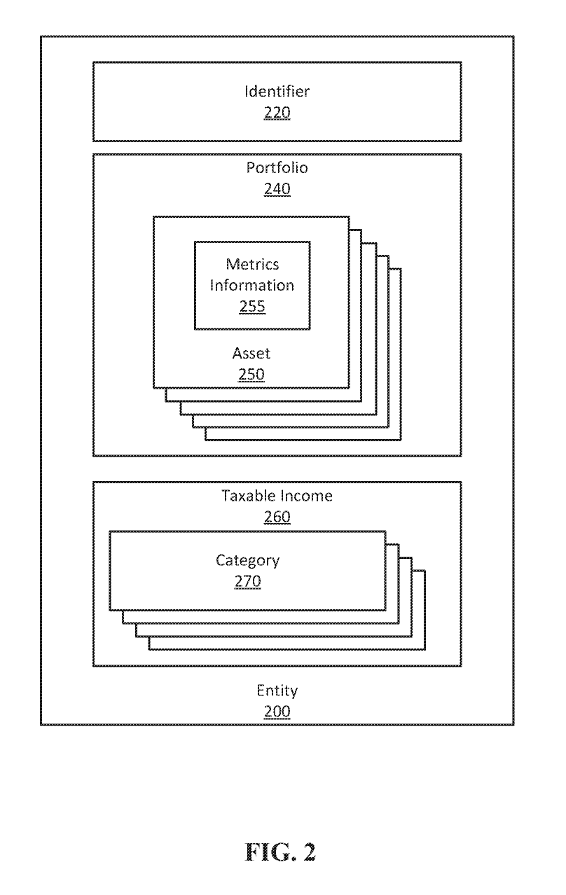

The present system and method 100 contains the tax network module 110 which is used to sort a provided set of entities 200, as shown by FIG. 2, each of which may include an identifier 220 (e.g., a name) and is either a taxpayer or an entity, such as, but not limited to, a partnership, corporation, bank, etc. As a result, the tax network module 110 (FIG. 1) provides a tax network which is used by the present system and method 100 (FIG. 1) as described herein.

In addition to the identifier 220 identifying the type of entity 200, each entity 200 owns a portfolio 240, which is a set of assets 250, which may associated with the one or more entities 200 by the tax network module 110. Each asset 250 has information 255 regarding metrics such as, for example, but not limited to, its fair market value (FMV) at a given time, its adjusted basis and any other relevant tax or financial information. Additionally, an asset 250 may be one of many types, such as cash, stocks, real estate, a share in a partnership, etc. In addition, each entity 200 has information regarding its taxable income 260 of all possible categories 270, which is associated to the entity 200 by the tax network module 110 (FIG. 1). As a result, the tax network module 110 (FIG. 1) provides a relationship between one or more entity 200, associated asset(s) 250, and taxable income categories 270, for use by the present system and method 100 (FIG. 1). As would be known by one having ordinary skill in the art, an example of a category 270 of income is defined as the names of entries 1-14 on a schedule K−1 form describing a partnership tax allocation.

As provided herein, the fair market value is defined as the price that an asset 250 or a piece of property is worth on the market, given that all market participants have perfect information and provided that the asset may provide future income streams. In addition, as provided herein, the adjusted basis is the cost that a taxpayer or entity incurred in acquiring a piece of property after adjusting for other consequential costs. While the word basis is used to define the original cost, adjusted basis is more accurate for tax purposes. An example of a basis adjustment is when a taxpayer claims depreciation deductions on a piece of property, in which case the adjusted basis is decreased.

The tax network at a given time is defined as a list of entities 200 (a term which we define to encapsulate taxpayers and entities (e.g., partnerships)), each of which owns a set of assets 250. At any point, the state of the network can be described as some γ ∈ Γ, where γ={e, a, d}, where e={eᵢ}ᵢ₌₀^{k}^{₁} is the set of entities 200, a={aᵢ}ᵢ₌₀^{k}^{₂} is the set of all assets and k₁, k₂ ∈ [symbol] , eᵢ ∈ Eᵢ aᵢ ∈ A. The operator d determines the owner of each asset 250, i.e., a^{T}: A [symbol] E, where A is the space of assets 250 and E is the space of entities 200.

The present system and method 100 provides the transaction sequence module 120 to represent financial activity. The transaction sequence module 120 provides and manages a list of transactions as carried out in a particular order. A single transaction includes two entities 200 (or tax payers, or a combination of tax payer and entity) and two assets 250 (or two sets of assets). The entities 200 are signified by their identifier 220. The assets 250 are categorized by their type and fair market value (FMV), except for cash (and potentially things such as annuities), which can be set to an arbitrary amount. For example, a transaction that looks like (Mary, ACME, Cash, House(300)) would describe a situation where Mary is buying a house from partnership ACME that is worth $300. While the price of the house must be specified, the cash simply matches the FMV of the other asset being exchanged.

A sequence of transactions may be defined as a vector t={tᵢ}ᵢ₌₀^{k} for some k ∈ [symbol] , t ∈ T is the space of all transactions. A transaction is defined as t={e_{f}, eₜ, a_{f}, aₜ} where e_{f}, eₜ ∈ E are two assets 250 that are being exchanged between the two entities 200.

Returning to FIG. 1, the present system and method 100 provides an audit score sheet module 130, which represents auditing policy structure. The audit score sheet module 130 provides a list of observable events that can occur within a transaction sequence of the transaction sequence module 120, where each observable event has a corresponding weight to it. All of the weights must add up to one. As provided herein, an observable event is a taxable event that an auditor could see. Elements provided by the audit score sheet module 130 include, not only all observable events, but all possible iterations of their joint occurrences. Joint occurrences are the union of multiple observables within the same audit score sheet. For example, for three events a, b and c, their join occurrences are a-b, a-c, b-c and a-b-c. As described further herein, the audit score sheet module 130, in representing n observables, will have 2ⁿ−1 elements.

The purpose of an audit score sheet, as provided by the audit score sheet module 130, is to determine the likelihood of conducting an audit of a partnership tax return, which is a set of information regarding a set of taxpayers and entities 200, along with a sequence of transactions between them. Thus, the audit score may be calculated as the sum of all of the audit points, each multiplied by the frequency that its associated observable event occurs in the transaction sequence of the transaction sequence module 120. That audit score is the metric used to represent the relative likelihood that a certain tax return should be audited.

A tax auditor is represented as a list of observable events, each with an associated positive real number between 0 and 1, which are called audit points. In order to simulate resource constraints, the audit points sum to exactly 1, as previously mentioned. The list of all observable events with their associated audit points is referred to as the audit score sheet. One can imagine a hypothetical auditor scanning a set of financial documents and noting when an observable event is present.

The events on the audit score sheet can range from basic facts about a transaction, such as whether a stock is being exchanged, to more complex aspects of the entity structure state, such as ownership linkages between multiple entities 200 (FIG. 2). An observable event is one that is possible to detect in the tax ecosystem model, but not necessarily by the auditor. For example, if a taxpayer purchases a share in a partnership for cash, the present system and method 100 will process that as a transaction involving a partnership asset, as well as tracking all parties involved in the transaction, while in reality, that information might not be accessible in the financial documentation. Three possible types of events are observable within the present system and method 100: 1) events that are possible to observe; 2) events that may be impossible or very difficult to observe, but can be captured with an observable proxy; and 3) events that are impossible to observe due to either logistical or legal reasons. Inspiration for this modeling approach was gathered from the way in which the IRS in the past has amended the tax code to prevent what are believed to be abusive tax shelters. For example, in 2004 the IRC was altered in §743 (a) to read:
The basis of partnership property shall not be adjusted as the result of (1) a transfer of an interest in a partnership by sale or exchange or on the death of a partner unless (2) the election provided by §754 (relating to optional adⱼustment to basis of partnership property) is in effect with respect to such partnership or (3) unless the partnership has a substantial built-in loss immediately after such transfer.

The abovementioned adds numbers in parenthesis to signify observable events: (1) The sale of a partnership interest in exchange for a taxable asset. (2) The partnership whose shares are being transferred has not made a §754 election. (3) The basis of the seller in respect to the non-cash assets owned by the partnership exceeds their FMV by more than $250,000.

For example, supposing that the three events above were the only observable events, the template for an audit score sheet would be as shown in table 1 below.

TABLE 1

| Observable | Points | Frequency |
|---|---|---|
| AUTHOR | NIEVES. | PAN |
| CLIENT | MASSAC | 17614 |
| MATTER | TM: TAX | 5129P |
| PRACAREA | PATENTS | PAT |
| DOC TYPE | PATENT | PATENT |
| 2 U 3 | Point2 U 3 | Frequency2 U 3 |
| 1 U 2 U 3 | Point1U2U | Frequency1U2U |

For table 1, each row has three columns with 1) the type of observable corresponding to the three characterized observables from the IRS notice, 2) the associated audit point, and 3) the number of times it occurs in a list of transactions.

Not only is the occurrence of any of the individual events a row on the audit score sheet, but all possible combination of their occurrences are assigned an audit point as well. This allows for an auditor to ignore the occurrence of common events, such as the simple sale of a partnership interest, while being able to encapsulate scenarios in which they may indicate abuse or non-compliance. Thus, if there are m individual observable events, then there will be 2^{m}−1 elements on an audit score sheet, each of which is assigned an audit point.

Suppose that there are m specific types of events that are observable, represented by {bᵢ}ᵢ₌₀ⁿ, where n=2^{m}−1. Associated with each type of event are the audit points {aᵢ}ᵢ₌₀ⁿ, a ∈ [symbol] and the frequency that the event occurs within a network of transactions {fᵢ}ᵢ₌₀ⁿ, fᵢ ∈ [symbol] . The audit score, s may be written corresponding to the audit score sheet and network of transactions as

$$s = {\sum }_{i = 0}^{n} {α}_{i} {f}_{i} where {\sum }_{i = 0}^{n} {α}_{i} = 1 \qquad ( Eq . 1 )$$

The present system and method 100 contains a legality check module 140 for determining the tax consequences of each individual transaction in the sequence, specifically, whether or not the transaction can occur. This includes the use of a set of decision trees that take into account both the legality and feasibility of each transaction. For example, Mary cannot purchase a $300 house with cash if she does not have at least $300 in cash. Since one having ordinary skill in the art would know how to implement decision trees for purposes of confirming whether a transaction can occur, decision trees are not described in additional detail herein. Suffice to say that such questions and logic for decision trees may be stored within the memory or storage device of the present system 100.

It is noted that if the legality check module 140 confirms that a specific transaction is not legal or feasible, the present system and method 100 may not use this transaction for further calculations, such as for calculating the audit score or taxable income.

For the legality check, it is noted that laws governing a given transaction depend on the “type” of assets and entities being exchanged. For example, the laws governing the exchange of a hotel for cash between two taxpayers are different from those governing the contribution of an annuity to a partnership in exchange for a share. Thus, the laws governing a given transaction may be determined by the combination of both asset and entity types.

Consider the transaction t=(e_{f}, eₜ, a_{f}, aₜ), which states that entity e_{f} gives eₜ the asset a_{f} in exchange for aₜ. Define Ê to be the finite set of entity types, and Â to be the finite set of asset types. The set of all transactions may be written as a union of disjoint subsets T=∪ᵢ₌₀ⁿTᵢ, where each subset contains all transactions of a certain combination of asset an entity types. The steps that follow include:
1. a transaction type t is first checked to see if it is within the bounds of the legal/feasible region by first determining to which subset Tᵢ it belongs. We define μ: Tᵢ [symbol] φ as a map from a subset Tᵢ ∈ T to φ that determines the laws ® that govern the transaction, given its combination of asset/entity types.
2. the transfers in the two actions composing the transaction represent the transition of the network state γₜ to γₜ₊₁ and γₜ₊₁ to γₜ₊₂ according to the map τ: T×Γ [symbol] Γ
3. Taxable income calculation takes a transaction t and a network state γₜ and maps it to a taxable income value Θ for each table entity and an updated network state,

P:T×Γ [symbol] [symbol] ×Γ (Eq. 2)

The present system and method 100 also contains a transfer module 160 for transferring assets if the transaction checked by the legality check module 140 can occur. This process includes changing the portfolio 240 (FIG. 2) of a relevant entity 200 (FIG. 2). For example, taking $300 in cash out of Mary's portfolio and putting in Mary's portfolio a house instead to replace the $300 asset. In accordance with one embodiment of the invention, some transactions can consist of forming an entity 200 (FIG. 2), so the transferring step performed by the transfer module 160 could also include the establishment of a partnership, or other entity, if it is deemed a legal transaction.

The present system and method 100 also contains an adjustment module 170. Specifically, the next step of transaction processing depends on whether the transaction is taxable. If it is, the adjusted basis of many of the relevant assets is changed by the adjustment module 170, and the taxable incomes of the relevant non-flow-through entities 200 are updated.

Calculation of tax liability incurred by taxpayers or other entities 200 (FIG. 2) while owning an interest in flow-through entities can become very complex. But from a bird's eye view, the allocation of gain and loss through flow-through entities is merely a series of accounting rules that are triggered by a set of events, namely transactions.

A formal representation of income allocation through partnerships, as described by subchapter K of the US Internal Revenue Code (IRC), can prove very useful for accountants looking to verify tax compliance, auditors looking to determine fraudulent calculations, and anybody looking to learn more about partnership tax. It is noted that the present exemplary tax liability calculation is applicable to entities other than partnerships.

The following describes how the IRC dictates that tax accounting should be handled within partnerships. The following example describes a single partnership, each with an arbitrary number of partners. After formation, partners can enter the partnership by either a) contributing an asset, or b) purchasing part or all of a pre-existing partner's share.

Partnership tax accounting can be thought of as a system of partners and assets, where the FMV of the assets is a continuous function, but all other fields are changed only when an event occurs. That is, suppose an event occurs at time t>\hat{t} ∈ [symbol] , and while the event preceding it occurred at time \hat{t} ∈ [symbol] . Before processing the event, all tax consequences for the partners arising from FMV changes between times \hat{t} and t are taken into account. The lapse between times is irrelevant, all that matters is that an event must occur. These events include:

1. Sale of a partnership interest

2. A distribution, liquidating or non-liquidating

3. Sale of property held by the partnership to a third-party

4. Contribution of an asset by a third-party to gain entry into the partnership

Assets

An asset is a tuple (t, β, τ) ∈ A consisting of
Adjusted Basis: A scalar b ∈ [symbol]
Book Value: A scalar β ∈ [symbol]
Type: A positive integer τ that whether the asset is category 0 (cash), category 1 (ordinary) and category 2 (capital)

This assumes that all assets are non-depreciable.

The set of all assets A is defined as the union of three disjoint subsets

A=A₀ ∪ A₁ ∪ A₂, where
A₀ is the set of all category 0, defined here as any cash
A₁ is the set of all category 1 assets, and
A₂ is the set of all category 2 assets

Partners

A partner may be a tuple (θ, κ, ε, σ) ∈ P consisting of
Ordinary Income: A scalar θ ∈ [symbol] that represents recognized ordinary taxable income
Capital Income: A scalar κ ∈ [symbol] that represents recognized capital gain
Shares: A vector s=[s₁, s₂, s₃],sᵢ ∈ (0, 1) that represents the partner's share of, respectively partnership income, capital gains and losses as specified in the §704(b) partnership agreement.
Outside Basis: A scalar σ ∈

[symbol]

A partnership has three functions that returns information regarding partners and assets. A is the space of all partnership assets and E is the space of all partners that are partners in the partnership
FMV (F(a, t): A× [symbol] → [symbol] ): A function F(a, t) that returns the fair market value (FMV) of asset a at time t
Built-in Income (φⁱ: E×A→ [symbol] ): A function φⁱ(e, a) that takes in a partner and an asset an returns the amount of built-in gain or loss allocated to partner e from asset a as a time i.
Accrued Income (Γⁱ: E×A→ [symbol] ): A function Γⁱ(e, a) that takes in a partner and an asset an returns the amount of gain or loss allocable to partner e from the change in FMV of asset a in respect to either the time at which the a) partnership acquired the asset or b) partner acquired a share in the partnership as of time i.

When referring to an element of a partner or asset tuple, subscript notation is used in reference to the variable and superscript in reference to the time at which that variable holds a particular value. For example, for a variable x defined as the sum of an asset a's basis at time t and a partner p's outside basis at time t, is denoted as x^{t}=a_{b}^{t}+p_{σ}^{t}. Note that similar to the notations for functions, a superscript notation is used to denote the time at which an asset's or partner's variable holds a particular value. That is, a_{b}^{t} denotes the value of a's adjusted basis at time t.

Defining another variable y as the difference between the built-in gain or loss of p in respect to a at time t and the accrued income of p in respect to a at time t, results in y^{t}=φ^{t}(p, a)−Γ^{t}(p, a). There are times at which the mappings of either the φ or Γ functions may be changed. For example, setting partner p's built-in gain in respect to asset a to 5 at time t, may be written as φ^{t}(p, a)=5.

The scalar share values for each partner is denoted by using sub-subscript notation. A partner p's share of partnership income at time t, is written as pₛ_{ᵢ}^{t}, because income may be represented by the first element in the share vector pₛ^{t}.

The present system and method 100 also contains an audit score module 180. The determination of audit likelihood depends on the audit score sheet and the types of observables that occur within a transaction sequence. Specifically, the audit score is the sum, over all elements in the audit score sheet, of each weight corresponding to a certain observable (or joint occurrence) multiplied by the frequency which it occurs.

In summary, a transaction sequence is applied to the tax network to produce total taxable income of all entities, and the audit score sheet produces an audit score in respect to the transaction sequence and tax network.

For exemplary purposes, a simulation is defined as a function F: T×Γ×ψ [symbol] [symbol] that takes as input a sequence of transactions, an initial tax network state and audit score sheet, and generates taxable income and an audit score. It should be noted that the audit score may be used as an input for a separate or co-existing application, such as that described in the co-pending provisional application entitled Method and System For Assessing Auditing Likelihood, Ser. No. 62/255,785, filed Nov. 16, 2015.

The following addresses the question, given an initial tax network, an audit score sheet, and requirements regarding the final tax network state, what sequence of transactions will minimize both taxable income and the audit score?

Different transaction sequences that produce the same economic result can generate very different tax consequences. Different methods of exiting a partnership can be strategic for both the exiting and existing partners. In a simplified example, a partner could sell their interest in a partnership or take a liquidating distribution and incur a certain tax liability. Alternatively, they could (1) take out a large loan through the partnership to increase their share of liabilities, then (2) sell a majority of their interest to a third party, while maintaining a negligible share in the partnership. This way, the partner receives close to the entire value of their interest in cash, while incurring a significantly smaller amount of tax.

Thus, assuming that there is a near infinite space of transaction sequences that produce the same (or similar) economic results, it is the goal of the tax planner to choose the “best” sequence by searching over all combinations of transaction sequences. This method assumes that a transaction sequence is of high value if it produces low levels of tax liability without arising suspicion from the IRS, i.e. generating a high audit score.

The following addresses the question, given an initial tax network, a transaction sequence and a required final tax network state, what vector of audit points will generate a high audit score when taxable income is low relative to other transaction sequences that produce the same economic result?

The optimization of an audit score sheet is essentially a method for classifying an abusive tax shelter. That is, the goal is to find the joint occurrence of observable events which perfectly describe the shelter, such as the three example observables previously mentioned. Not only does this result in every similarly abusive transaction sequence to be audited, but also prevents against “false positive” audits on legitimate transaction sequences.

Specifically, it is assumed that the value of an audit score sheet is based on a combination of the generated tax liability and the audit score. If a transaction sequence results in a low tax liability relative to other transaction sequences that produce similar economic results, then the audit score should be high. Conversely, average or high levels of tax liability should be associated with a low audit score so as not to waste auditing resources on routine, non-abusive transactions.

The goal laid out in transaction sequence optimization and audit score sheet optimization employs a method to search over a near infinite space of potential solutions, otherwise known as a search heuristic. For example, an embodiment of present system and method 100 may use a class of search heuristics known as Evolutionary Algorithms (EA). Due to previous work suggesting that tax planners and IRS policies co-evolve with one another, an algorithm based on neo-Darwinian concepts is a preferred method for finding optimal solutions.

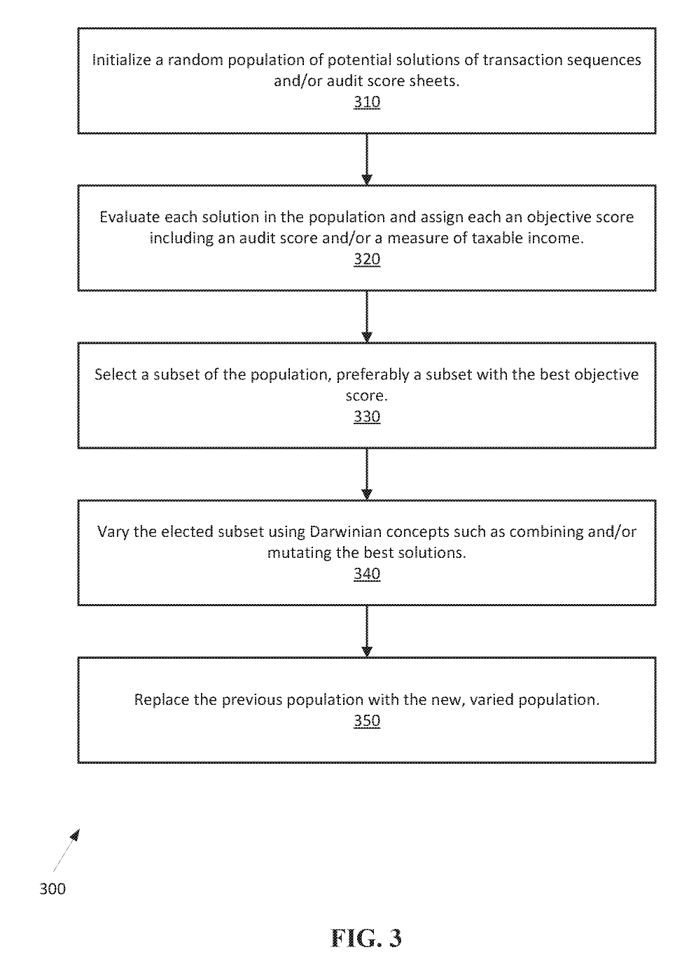

EAs use natural selection as the inspiration for finding an optimal solution in a near infinite search space. There are several steps to the process 300 described below, and shown in FIG. 3. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

A random population of potential solutions of transaction sequences and/or audit score sheets is initialized, as shown by block 310. The population of solutions refers to (a) transaction sequences, and/or (b) audit score sheets. When evolving transaction sequences, a single audit score sheet may be selected to evaluate the audit score for each potential solution. Conversely, a single transaction sequence may be selected to evaluate against each audit score sheet when evolving auditing procedures. Thus, each potential solution may be assigned both a measure of taxable income, as well as an audit score. Each solution in the population is evaluated and assigned an objective score including an audit score and/or a measure of taxable income, as shown by block 320. The assigning of objective scores to individuals in the population may be performed, for example, by the modules shown in FIG. 1. Evaluating may include selecting a size k subset of an opposing population, and then calculating the total objective score as a function of the objective scores from all k evaluations.

A subset of the population is selected, preferably a subset with the best objective score, for example, a subset of the population having an objective score above a predetermined threshold level, as shown by block 330. The selected subset is varied using Darwinian concepts such as combining and/or mutating the best solutions, as shown by block 340. The previous population is replaced with the new, varied population, as shown by block 350. Blocks 310-350 may be repeated.

This process may be described as a “uni-directional” EA because comparisons are made with a static objective. That is, all transaction sequences may generate their audit score based on the same audit score sheet. Similarly, all audit score sheets may evaluated against the same transaction sequence.

Given the two well-defined uni-directional EAs, a “bi-directional” EA, also known as a co-evolutionary algorithm, may be established. A population of individual tax payers (transaction sequences) may be presented with a population of individual auditors (audit score sheets). Rather than evaluating each solution based on a single objective, multiple solutions from the opposing population may be used.

Specifically, the evaluation process may be expanded by (i) selecting a size k subset of the opposing population, then (ii) calculating the total objective score as a function of the objective scores generated from all k evaluations. In this way, the dynamics between potentially abusive tax shelters and the response of the auditors may be studied and used to anticipate new iterations of abusive tax shelters.

In order to optimize using grammatical evolution, a mapping is established between the set of positive integers and the object being optimized. The following optimization may be implemented, for example in Java, as both a uni-directional and co-evolutionary search.

The process by which sequences of transactions and initial ownership network are generated may be described by defining a mapping Ξₜ: [symbol] [symbol] T×Γ that maps a list of n integers to an element in the set of sequences of transaction (T) and an element in the set of all ownership networks (Γ). Thus, for any x ∈ [symbol] , Ξₜ(x)=(t, γ₀) where t ∈ T is a sequence of transactions and γ₀ ∈ Γ is an initial network.

The space of auditing observables may be defined as Ψ, where for some m ∈

[symbol]

$$Ψ = \{ {\{ {b}_{i} \}}_{i = 0}^{m} \text{:} {b}_{i} ∈ [ 0 , 1 ] and {\sum }_{i = 0}^{m} {b}_{i} = 1 \} ⋐ {ℝ}_{+}^{m} \qquad ( Eq . 3 )$$

The map Ξₐ: [symbol] [symbol] ψ maps a vector y ∈ [symbol] to an element in the set of auditing behavior.

The function F can be broken up into a network of transition functions that has the same length as the number of transactions in the transaction set contained within the function call (k). Each transition function generates a new network state and an audit score. So for all i ∈ [0, k], Fᵢ(tᵢ, γᵢ, ψ)=(γᵢ₊₁, sᵢ) where s=sₖ

It is desirable for a taxpayer to minimize both audit likelihood and taxable income. First of all, each set of transactions generates a taxable income, η. Secondly an audit score sheet generates an audit score, s based on a network of transactions, which represents the likelihood that a scheme will be audited, i.e. the risk of being audited. Thus, the fitness function, h for a tax evasion scheme may be represented, given a specific audit score sheet, as hₑ(η, s).

The goal of the auditor is to maximize the likelihood of an audit of a network of transactions with low taxable income. The fitness function for an audit score sheet given a specific tax evasion scheme is a function which reflects such a relationship, represented by hₐ(η, s). An audit score sheet is fit for a specific evasion scheme if either 1) there is not a suspiciously low amount of taxable income, or 2) if there is a high likelihood that if not much tax is collected, then the scheme will be audited.

Regarding how to judge the fitness of a network, for example, a network of transactions t and an auditing behavior ψ based on the taxable income η and audit score s generated from the tax ecosystem model F, it is possible to fully define the maximizing objectives of networks of transactions as

$$arg {max}_{{x}^{*} ∈ X} [ {h}_{e} ( F ( {Ξ}_{t} ( {x}^{*} ) , {Ξ}_{a} ( y ) ) ) ] = arg {max}_{{t}^{*} ∈ T - {γ}_{0}^{*} ∈ Γ} [ {h}_{e} ( F ( {t}^{*} , {γ}_{0}^{*} , ψ ) ) ] \qquad ( Eq . 4 )$$

over all y ∈ B(ŷ, r₁) for some ŷ ∈ [symbol] , where B(ŷ, r₁) is a ball of radius r₁ ∈ [symbol] around ŷ. This represents the fact that the goal of the GA is to find local maxima around some subset of auditing behavior, rather than attempting to search the entire φ space. Conversely the objective for the auditing behaviors is to maximize the hₐ function, i.e., the goal is

$$arg {max}_{{y}^{*} ∈ {Z}_{+}^{m}} [ {h}_{a} ( F ( {Ξ}_{t} ( x ) , {Ξ}_{a} ( {y}^{*} ) ) ) ] = arg {max}_{{ψ}^{*} ∈ Ψ} [ {h}_{a} ( F ( t , {γ}_{0} , {ψ}^{*} ) ) ] \qquad ( Eq . 5 )$$

over all x ∈ B(\hat{x}, r₂) for some \hat{x} ∈ \ddot{X}, where B(\hat{x}, r₂) is a ball of radius r₂ ∈ [symbol] around \hat{x}. Similar to the previous objective function, this represents the fact that the EA only searches for local maxima around a subset of all transaction sets and initial model states.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

We claim:

1. A computer-based system for providing a determining the likelihood of detection of non-compliance of a taxpayer, comprising:
a tax network module defining a tax network comprising at least two entities, where each entity has at least one set of assets;
a transaction sequence module 120 defining and managing at least one transaction, wherein a transaction includes at least two entities and a financial transaction taking place between the entities;
an audit score sheet module 130 which provides a list of observable events that can occur within a transaction sequence of the transaction sequence module 120, where each observable event has a corresponding weight;
a legality check module 140 which determines whether or not the transactions defined by the transaction sequence module 120 can occur;
a transfer module 160 for transferring assets if the transaction checked by the legality check module 140 can occur;
an adjustment module 170 for adjusting the basis of relevant assets of the tax network associated with the checked transaction, and determining taxable incomes of the entities associated with the checked transaction; and
an audit score module 180 for determining an audit score for the checked transaction.

2. The computer-based system of claim 1, wherein an entity comprises one of the list consisting of a taxpayer and a corporate entity.

3. A method for execution by a processor configured to execute non-transitory instructions stored in a memory, comprising the steps of:
initializing a random population of potential solutions of transaction sequences and/or audit score sheets;
evaluating each potential solution in the population and assign each an objective score comprising an audit score and/or a measure of taxable income;
selecting a subset of the population with an objective score meeting a predefined criteria;
varying the elected subset using Darwinian concepts; and
replacing the previous population with the new, varied population.

4. The method of claim 3, wherein the Darwinian concepts comprise combining the subset of the population.

5. The method of claim 3, wherein the Darwinian concepts comprise mutating the subset of the population.

6. The method of claim 3, wherein evaluating further includes the steps of:
selecting a size k subset of an opposing population; and
calculating the total objective score as a function of the objective scores from all k evaluations.

7. The method of claim 3, further comprising the steps of:
representing a taxable entity as a nodes with recorded taxable incomes; and
representing ownership relations between a first entity and a second entity as an edge.

8. The method of claim 3, further comprising the step of fact checking an economic transaction for legality and/or feasibility.

9. The method of claim 8, further comprising the step of updating the taxable income of an entity associated with the economic transaction.

10. The method of claim 9, further comprising the steps of:
identifying a set of observables within a transaction, and
associating a numerical value with each observable of the set of observables.

11. The method of claim 10, further comprising the step of generating an audit score as a function of the numerical values and the frequency that the observables occur within the list of transactions.
